(19) United States
(12) Patent Application Publication
(10) Pub. No.: US 2008/0230321 A1
(43) Pub. Date: Sep. 25, 2008

(54) PORTABLE FREESTANDING ELEVATOR

(76) Inventors: Frank Csaszar, Woodbridge (CA); Leslie Frank Csaszar, Sharon (CA)

Correspondence Address: BERESKIN AND PARR, 40 KING STREET WEST, BOX 401, TORONTO, ON, M5H 3Y2, CA

(21) Appl. No.: 11/688,051

(22) Filed: Mar. 19, 2007

(51) Int. Cl. B66B 9/16

(52) U.S. Cl. 187/244

(57) ABSTRACT

A mobile elevator apparatus for transporting people between a ground surface and a raised landing of an adjacent structure includes a base having wheels for rollably supporting the base on a ground surface, a tower frame having a lower end mounted to the base and an upper end above the lower end, the vertical distance between the upper and lower ends defining a frame height. The apparatus includes a track secured to the tower frame and extending generally between the lower and upper ends thereof, and an elevator car coupled to the track and movable therealong between raised and lowered positions.

### FIELD

The teaching described herein relate to portable elevators, and more particularly to portable freestanding elevators.

### BACKGROUND

U.S. Pat. No. 2,671,530 (White) describes a portable elevator, which can be delivered to a construction site while being stowed on a truck in a horizontal position and then raised into an operative position adjacent a building structure. In a horizontal inoperative position, the elevator resembles a trailer and has a height less than 12.5 ft corresponding with the minimum height of bridges.

U.S. Pat. No. 5,941,347 (Pfleger) describes a portable elevator for transporting cargo between different vertical levels of a building. The lift comprises a frame mounted for movement on a plurality of wheels. A carriage having a cantilevered platform adapted to support cargo is mounted to the frame for vertical movement between a lower level and an upper level. The wheels can be manually moved between a lower supporting position where the wheels support the frame for movement, to an upper non-supporting position. Movement of the wheels to the upper non-supporting position automatically engages a locking mechanism to lock the frame to the building to prevent accidental movement of the frame during a loading operation. The platform of the carriage can be selectively positioned at either a lower position to receive cargo from mechanical handling equipment, or at an upper position to receive a manually carried cargo.

### SUMMARY

The following summary is intended to introduce the reader to this specification but not to define any invention. In general, this specification discusses one or more methods or apparatuses pertaining to a mobile elevator apparatus for transporting people between a ground surface and a raised landing of an adjacent structure. In one example, the apparatus comprises a base including wheels for rollably supporting the base on a ground surface, a tower frame having a lower end mounted to the base and an upper end above the lower end, the vertical distance between the upper and lower ends defining a frame height, a track secured to the tower frame and extending generally between the lower and upper ends thereof, and an elevator car coupled to the track and movable therealong between raised and lowered positions.

In some examples, the base comprises a propulsion device coupled to at least one of the wheels for moving the base over the ground surface. The base can include a steering mechanism coupled to at least one of the wheels for steering the base when moving over the ground surface.

In some examples, the tower frame can be self-supporting when the elevator car is raised and lowered. The tower frame can include a first latticework around an open shaft extending vertically through the tower frame. The elevator car can be vertically movable within the shaft. The track can comprise a second latticework secured to the tower frame at a plurality of connection points along the height of the track. The upper end of the tower frame can be at greater elevation than the raised landing of the adjacent structure. The first latticework and second latticework can have heights about equal to the frame height. The frame height can be at least about 15 m. The tower frame can have a frame weight of about 5000 kg, and the base can have a ballast weight of about 20,000 kg. The ballast weight can comprise base frame members joined together and having the wheels joined thereto. Each of the wheels rotates about a wheel axis, and the wheel axes can be aligned in a generally horizontal axle plane, and the base can have a center of gravity generally equal to or less than the elevation of the axle plane.

In some examples, the apparatus can include outriggers joined to the base, each outrigger including a connection end pivotally connected to the base and a foot end opposite the connection end, the outriggers movable between a retracted position in which the foot ends are clear of the ground surface and a deployed position in which the foot ends bear against the ground surface for stabilizing the apparatus thereon.

In another example, a mobile elevator apparatus for transporting people between a ground surface and a raised landing of an adjacent structure comprises a base including wheels for rollably supporting the base on a ground surface, a propulsion device coupled to at least one of the wheels for moving the base over the ground surface, and a steering mechanism coupled to at least one of the wheels for steering the base when moving over the ground surface; a tower frame having a lower end mounted to the base and an upper end above the lower end, the vertical distance between the upper and lower ends defining a frame height; the tower frame including a first latticework around an open shaft extending vertically of the tower frame; a track extending generally between the lower and upper ends of the tower frame, the track comprising a second latticework secured to the tower frame between the lower and upper ends thereof; and an elevator car disposed within the shaft and coupled to the track, the elevator car movable along the track between raised and lowered positions.

In another example, a method of providing vertical transport from a ground surface to a gangway of a ship comprises providing a mobile elevator apparatus and driving the apparatus to a position adjacent said ship with the tower in alignment with said gangway. The method can be free of anchoring the apparatus to the ship. The method can include providing the apparatus with a controller including at least one sensor for stopping upward motion of the elevator car when in the raised position, and further comprising the step of positioning a triggering element along the tower frame to trigger the sensor when the elevator car is in the raised position. The controller comprises a menu of ship names to be serviced, the at least one sensor having a corresponding position for each ship name, and wherein the method includes selecting the ship name of said ship being serviced to set the elevation of the elevator car when in the raised position.

Other aspects and features of the present specification will become apparent, to those ordinarily skilled in the art, upon review of the following description of the specific examples of the specification.

### DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of a portable elevator;

FIG. 2 is a front view of the portable elevator of FIG. 1;

FIG. 3 is a side view of the portable elevator of FIG. 1;

FIG. 4a is a side view of an elevator car portion of the elevator of FIG. 1;

FIG. 4b is a top view of a portion of the portable elevator of FIG. 1; and

FIG. 5 is a plan view of the mobile base portion of the portable elevator of FIG. 1.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors or owners reserve all rights that they may have in any invention disclosed in an apparatus or process described below that is not claimed in this document, for example the right to claim such an invention in a continuing application and do not intend to abandon, disclaim or dedicate to the public any such invention by its disclosure in this document.

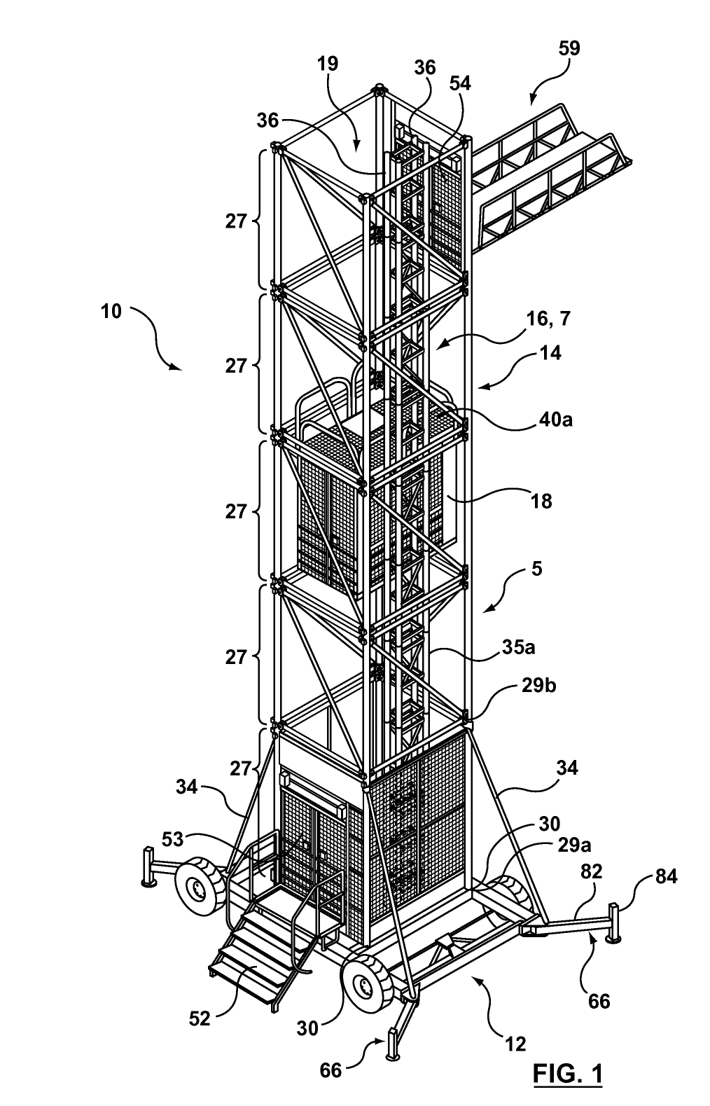

Referring to FIG. 1, illustrated therein is a perspective view of an example of a portable elevator 10 including a mobile base 12, and a tower frame 14 affixed to mobile base 12. The interior of tower frame 14 is generally hollow and defines a shaft 19. A track 16 is secured to, and extends vertically along, the tower frame 14. The track 16 can also be affixed to mobile base 12. An elevator car 18 can be coupled to the track 16 for movement therealong, between raised and lowered positions.

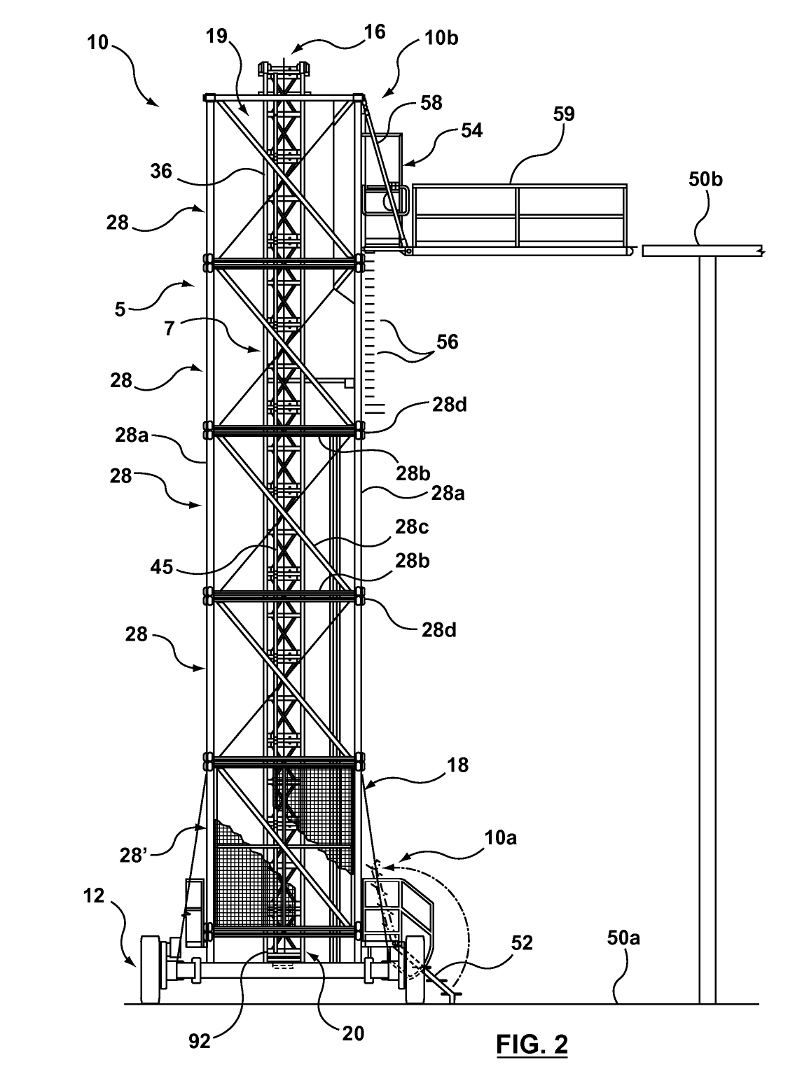

Motion of elevator car 18 is controlled by a drive mechanism 20 (see FIG. 2) that may be attached to support frame 16 and elevator car 18. As shown in the illustrated embodiment, drive mechanism 20 is configured as a traction elevating system as will be described in greater detail below. In some embodiments, other elevating systems may be utilized, for example, hydraulic elevating systems.

The tower frame 14 can be configured as a first latticework 5 of elongate members arranged around the shaft 19. The first latticework 5 can comprise a plurality of tower sections 27 stacked vertically to form the tower frame 14. Each tower section 27 can include a plurality of side panels 28 comprising members of the latticework 5 arranged in load distributing, truss-like configuration.

In the example illustrated, the tower frame 14 comprises five vertically stacked tower sections 27. Each tower section 27 comprises four side panels 28 (also referred to herein as trusses 28). The four side panels (or trusses) 28 in each tower section 27 are at a common elevation and arranged in a box formation around the perimeter of the shaft 19.

Each truss 28, in the example illustrated, comprises two spaced-apart vertical members 28a, two spaced-apart horizontal members 28b extending between the vertical members 28a, and a diagonal member 28c. Each member 28a, 28b, 28c can be made of steel, aluminum, or other structural material. In the example illustrated, the members 28a, 28b, 28c are of tubular aluminum. In other examples, the members 28a, 28b, 28c can be of hollow or solid steel.

Vertical members 28a and horizontal members 28b interconnect at respective ends to form a rectangular frame. Diagonal member 28c connects from one corner of the rectangular frame to an opposing diagonal corner in order to stiffen the rectangular frame. Members 28a, 28b, 28c may be connected using corner brackets 28d or other similar joints, including pin joints and welded joints. Corner brackets 28d may also allow interconnection of trusses 28, for example, when connecting trusses between or within truss sections 27.

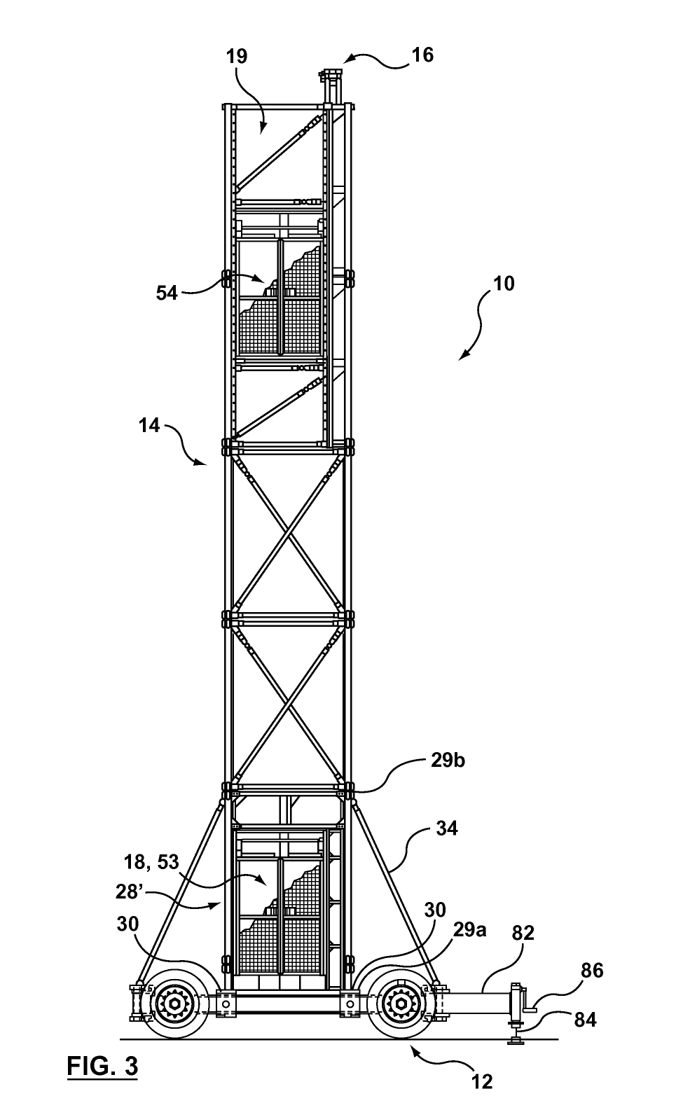

Referring to FIG. 3, the lower corners 29a of the bottommost trusses 28′ are affixed to mobile base 12 using fasteners 30, which may include bolts, brackets, welds and the like. Upper corners 29b of the bottommost truss 28′ are, in the example illustrated, connected to diagonal braces 34 which further connect to mobile base 12 at points that are radially outward from the truss structure of tower frame 14.

The track 16 is secured to the tower frame 14 and extends generally between lower and upper ends thereof. The track 16 can comprise a second latticework 7 secured to the tower frame 14 at a plurality of connection points along the height of the track 16. The track 16 can be positioned interiorly or exteriorly of the tower frame 14. In the example illustrated, the track 16 is positioned interiorly of the tower frame 14, i.e. in the shaft 19.

In the example illustrated, the track 16 comprises a second latticework 7 of elongate members that are smaller in size than the elongate members 28a, 28b, 28c of the first latticework 5 of the tower frame 14. The second latticework 7 includes vertical members 35a that are, in the example illustrated, about half the height of the vertical members 28a of the first latticework 5.

The first and second latticeworks 5, 7 can be of generally equal height, and can have a height generally equal to that of the tower frame 14. In the example illustrated, tower frame 14 has approximate dimensions of 15 m high, 2.6 m long, and 2.1 m wide. The track 16 has approximate dimensions of 15.6 m high, 0.5 m long, and 0.2 m wide. Such dimensions are generally suitable for using a portable elevator in, for example, a ship harbor to load and unload boats, people, materials, etc. In some embodiments, tower frame 14 and support frame 16 may be of different dimensions, for example, tower frame 14 may be higher than 15 m.

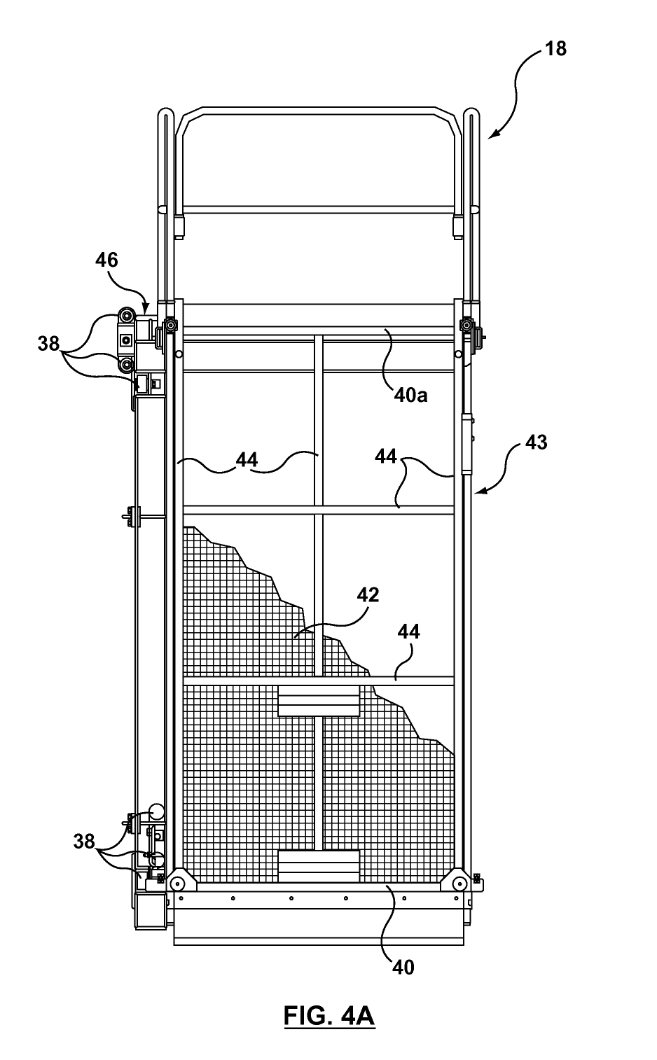

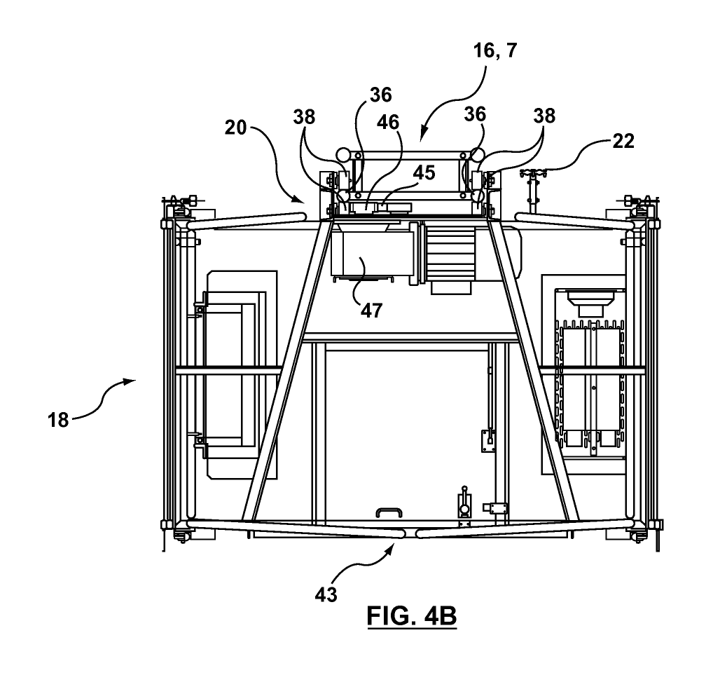

Referring now to FIG. 4a, illustrated therein is a side view of elevator car 18. Elevator car 18 includes a floor 40 and sidewalls 42 thereby forming an enclosure that may be used to transport people, cargo, or other objects. The elevator car 18 can further include a roof panel 40a, spaced apart from the floor 40 a sufficient distance (e.g. 2.5 m) to accommodate the height of an occupant standing in the elevator car 18. Elevator car 18 can be made from a cubical frame of interconnecting struts 44 extending from floor 40 with a wire mesh covering openings on the sides of the cubical frame to form sidewalls 42. At least one side of elevator car 18 is provided with an elevator door 43 (see FIG. 4b) that may be opened or closed to allow loading and unloading of elevator car 18. The configuration of elevator car 18 provides a safe enclosure that generally satisfies safety requirements for elevators that carry people. Such requirements can include those set out in, for example, CSA code Z-185.

Referring to FIGS. 4a and 4b, the track 16 can comprise a pair of rails 36 (see FIG. 1) extending along the second latticework. The rails can be engaged by rollers 38 secured to the elevator car 18 (see FIG. 4). The rollers 38 may be attached to respective struts 44 using mounting brackets 46. Each rail 36 may be simultaneously engaged by a number of rollers 38 at different locations to support elevator car 18 on support frame 16. For example, rollers can engage each rail on opposite sides thereof, and/or rollers 38 can engage each rail simultaneously at spaced-apart heights along the rail 36. As drive mechanism 20 moves elevator car 18 up and down, rollers 38 roll along rails 36 to guide elevator car 18. The rails 36 may form a part of the truss structure of second latticework 7 of the track 16. For example, one or more of the vertical members 35a can comprise the rails 36. In some examples, the rails 36 may be secured directly to the tower frame 14, without any intervening latticework members.

Referring to FIGS. 2 and 4b, drive mechanism 20 is configured as a traction elevating system, which may include a rack 45 having a plurality of teeth formed on one surface for receiving a corresponding pinion 46 attached to elevator car 18. Pinion 46 can be driven by an elevator motor 47 on elevator car 18, which may be an electric motor, or as in the illustrated embodiment, a hydraulic motor.

As elevator motor 47 turns pinion 46, the teeth thereon engage with the teeth of rack 45. Because rack 45 is stationary relative to the track 16, the rolling engagement of pinion 46 on rack 45 moves elevator car 18 along shaft 19 depending on the direction of rotation of pinion 46. For example, rotating pinion 46 clockwise may raise elevator car 18, while rotating pinion 46 counter-clockwise may lower elevator car 18. The direction of rotation of elevator motor 47 and pinion 46 may be controlled by, for example, a console (not shown) within the elevator car 18 or a radio transceiver (not shown). It is noted that elevator car 18 generally includes a safety stop that can engage support frame 16 or tower frame 14 to slow down and stop elevator car 18 in the event that drive mechanism 20 may stop working. In other embodiments, different types of elevating systems may be used, for example, hydraulic lift systems or cable pulley systems.

Referring to FIG. 2, elevator car 18 can move up and down within shaft 19 between a lower landing 50a corresponding with a lower portion 10a of portable elevator 10, and an upper landing 50b corresponding to an upper portion 10b of portable elevator 10 (see FIG. 2). Lower and upper landing 50a, 50b may include, for example, levels of a building, a ship deck, an aircraft, or other structure.

Referring to FIG. 2, the bottom portion 10a of portable elevator 10 may be provided with a stairway 52 to provide access to elevator car 18 from lower landing 50a. As shown in the present embodiment, stairway 52 may be pivotally mounted to mobile base 12. Pivotal mounting allows stairway 52 to be foldable upward and inward toward mobile base 12 when driving portable elevator 10 between different locations. For example, in some dry docks, a synchro lift may be used to raise a ship out of the water. The apparatus 10 can be driven on to the synchro lift when raised, used to convey people on to and off the ship, and then driven clear of the synchro lift when the ship is to be lowered (i.e. when the synchro lift is submerged). The bottom portion 10a may also be provided with a lower entry door 53 that may allow access to elevator car 18 from lower landing 50a.

The top portion 10b of portable elevator 10 may be provided with a landing door 54 that provides access to and from elevator car 18 while at upper landing 50b. Landing door 54 can be a platform that is attachable to tower frame 14 at several vertical positions 56 to provide access to upper landings 50b of varying heights. Landing door 54 may be connected to tower frame 14 using fasteners, which may include, for example, bolts and brackets. As shown in the illustrated embodiment, landing door 54 may also include a diagonal support 58 that connects from the bottom outer edge of landing door 54 to a higher portion of tower frame 14. Diagonal support 58 can provide extra support to landing door 54.

Landing door 54 may be adaptable to receive a gangway 59 that provides a bridge from elevator car 18 to upper landing 50b. In the example illustrated, portable elevator 10 can wholly support gangway 59 such that there is no need to attach gangway 59 to upper landing 50b. This form of attachment allows portable elevator 10 to be freestanding with respect to upper landing 50b or a structure associated therewith.

The freestanding nature of portable elevator 10 can be particularly beneficial when operating in ship harbors where ships may, for example in a wet dock where ships are not raised from the water, come and leave in relatively rapid succession. By providing a freestanding portable elevator 10, cargo may be loaded on/off a ship without attaching the portable elevator 10 to the ship. If the ship needs to leave suddenly, portable elevator 10 does not need to be disengaged, but rather, the ship may leave while portable elevator 10 remains in place.

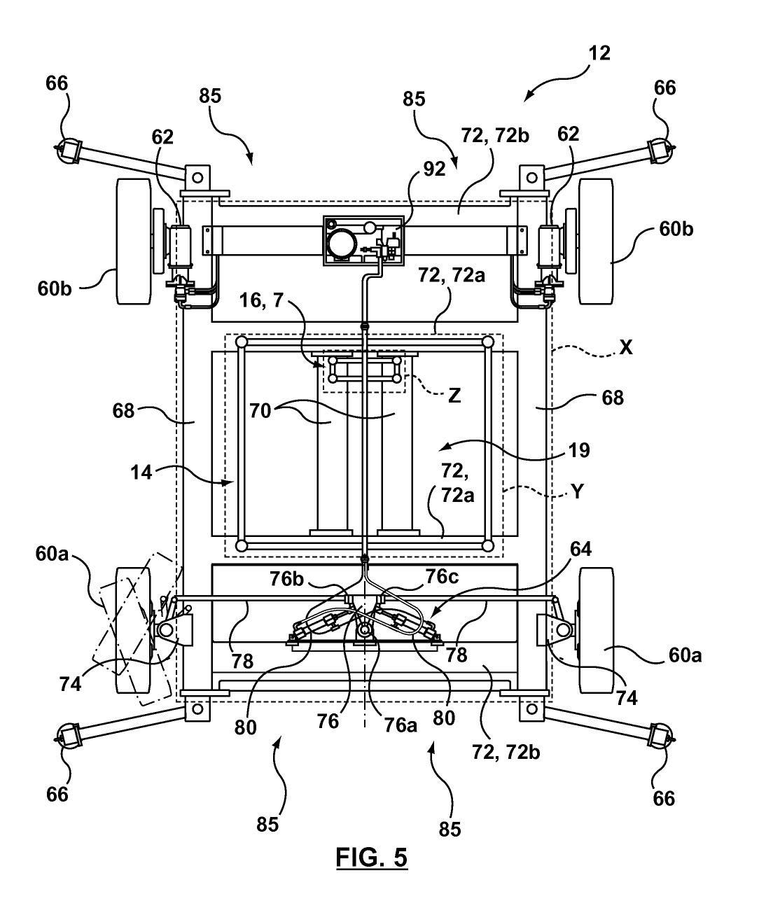

Referring now to FIG. 5, in the example illustrated, mobile base 12 includes wheels 60a, 60b, which may be coupled to drive units 62 and/or a steering mechanism 64 in order to drive and steer mobile base 12 between different elevating locations. Mobile base 12 may also include outriggers 66 that can help to steady portable elevator 10 once at an elevating location.

Mobile base 12 supports tower frame 14, track 16, and other portions of portable elevator 10. As shown, mobile base 12 includes a chassis formed from outer longitudinal rails 68, inner longitudinal rails 70, and cross rails 72. Cross rails 72 can include inner cross rails 72a and outer cross rails 72b. Inner longitudinal rails 68 and outer longitudinal rails 70 extend parallel to each other and are interconnected by cross rails 72. Rails 68, 70, 72 can be made of a plurality of I-beams made of steal, aluminum, or another suitable material. Rails 68, 70, 72 are connected together at joints that may include, for example, welds and brackets. In some embodiments, mobile base 12 may be made in other configurations, such as a single continuous structure of rails, for example, as in a carbon fiber mobile base.

In the example illustrated, the bottommost truss 28′ of tower frame 14 is affixed to mobile base 12 at inner cross rails 72a. The bottommost truss of the second latticework 7 is affixed to mobile base 12 at inner longitudinal rails 70 adjacent an inner cross rail 72a. Fasteners, such as bolts, welds and the like may be used to connect mobile base 12 to tower frame 14 and track 16.

Generally, mobile base 12 is configured to provide a stable foundation for tower frame 14, track 16, and other portions of portable elevator 10. In particular, mobile base 12 is designed to have a mass that stabilizes portable elevator 10, such that tower frame 14 and track 16 are free standing and do not require the use of attachments such as guy wires or ties that attach the track 16 to an external structure.

To further increase stability, mobile base 12 may have a perimeter X that is larger than a perimeter Y of tower frame 14 (perimeters X and Y shown in dashed line in FIG. 5). The boundary formed between by the outer longitudinal rails 68 and outer cross rails 72b (when viewed from above) may define perimeter X. The boundary formed by tower frame 14 when viewed from above may define perimeter Y. Generally, perimeter Y resides wholly within perimeter X, which can provide stability by providing a wide base for supporting tower frame 14. In the illustrated embodiment, the second latticework 7 has a perimeter Z defined by the outer boundary of the second latticework 7 when viewed from above. Generally, perimeter Z is enclosed by perimeter Y. In embodiments where the second latticework 7 extends outside of tower frame 14 (i.e. when perimeter Z does not reside within the area occupied by tower frame 14 when viewed from above), perimeter Y may be defined to enclose both tower frame 14 and the second latticework 7 (when viewed from above).

Mobile base 12 also provides, in the example illustrated, mobility to portable elevator 10 and includes two front wheels 60a, and two rear wheels 60b. The rear wheels 60b can be powered by two drive units 62, each of which may be coupled to a respective outer rail 40 and a respective rear wheel 60b. Drive units 62 may be powered by, for example, gas, electricity, or as in the illustrated embodiment, hydraulics. Drive units 62 may be in communication with a drive controller (not shown) so as to control the speed of portable elevator 10.

In the illustrated embodiment, hydraulic drive units 62 provide appropriate power to move portable elevator 10 at a speed of approximately 5 m/min. Such a speed is suggested as an upper limit for safety precautions. For example, higher speeds may result in unstable cornering or braking. In some embodiments, drive units 62 can provide both acceleration and braking.

In the example illustrated, drive units 62 do not provide power to front wheels 60a. Instead, front wheels 60a are pivotally mounted to outer rails 68 through wheel brackets 74 and are also coupled to steering mechanism 64 such that front wheels 60a may pivot about wheel brackets 74 upon activation of steering mechanism 64.

The described configuration of front wheels 60a and rear wheels 60b is known as a rear drive configuration and can provide appropriate torque to move portable elevator 10. In other embodiments, other types of drive configurations may be utilized, for example, front wheel drive or all-wheel drive configurations.

Referring to FIG. 5, the steering mechanism 64 can include a bell crank 76 mounted to mobile base 12 at a first pivot 76a of bell crank 76. Two control arms 78 are mounted to bell crank 76 at second and third pivots 76b, 76c respectively, and also connect to respective front wheels 60a. Accordingly, bell crank 76 may be pivoted about first pivot 76a to shift control arms 78 and turn front wheels 60a. Bell crank 76 may be pivoted, for example, using two actuators 80 mounted to the sides of bell crank 76 that face respective front wheels 60a. Actuators 80 may be, for example, hydraulic actuators or solenoids that are actuated using a steering controller (not shown).

In order to steer portable elevator 10 in a given direction, one actuator 80 retracts, and the other actuator 80 extends to rotate bell crank 76 about first pivot 76a. Each control arm 50 shifts according to the rotation of bell crank 76, thereby pivoting front wheels 60a about wheel brackets 74. The particular geometry of bell crank 76 and control arms 50 allows one front wheel 60a to turn more than the other front wheel 60a such that the turning radius of the wheels 60a, 60b generally share a common center of curvature. Such a steering mechanism can provide stable operation of portable elevator 10 when moving at the speeds suggested above. For example, steering mechanism 64 may reduce the possibility of slip on wheels 60a, 60b while cornering.

Outriggers 66 may be included with mobile base 12 to support mobile base when portable elevator 10 is in a desired position for elevating objects between upper and lower landing 50a, 50b. Each outrigger 66 may include a support arm 82, and a leg 84 connected to the support arm 82 (see FIG. 1). One end of each support arm 82 is connected to a respective corner of mobile base 12, while the other end is connected to a respective leg 84. When outriggers 66 are deployed, legs 84 can support portable elevator 10 or a portion thereof.

Legs 84 may be connected to support arms 82 by jacks 86. Jacks 86 may be actuated to extend legs 84 between deployed and undeployed positions. In other embodiments, outriggers 66 may be of different forms, for example, legs 84 may be operated using hydraulic cylinders, or outriggers 66 may be hinged legs that can pivot up and down between undeployed and deployed positions without support arms 82.

As shown in the illustrated embodiment, there may be four outriggers 66. Two front mounted outriggers 66 are connected to each outer rail 68 ahead of front wheels 60a, and two rear mounted outriggers 66 are connected to each outer rail 68 behind rear wheels 60b. Such a configuration of the four outriggers 66 can enhance stability when outriggers are deployed to support portable elevator 10.

Optionally, support arms 82 may be pivotally connected to outer rails 68 such that outriggers 66 may be folded inward toward mobile base 12 and stowed in recesses 85 of mobile base 12 when not in use. Each recess 85 may be located on respective front and rear portions of mobile base 12, generally between outer rails 68. Stowing outriggers 66 in recesses 85 can be beneficial when driving portable elevator 10 between elevating locations because the footprint of the portable elevator 10 is generally smaller when outriggers 66 are stowed.

In order to deploy outriggers 66, support arms 82 are folded radially outward from recesses 85 to positions where legs 84 may be deployed to at least partially support portable elevator 10 with an appropriate degree of stability. For example, each support arm 82 may be folded outward approximately 160° from the stowed position where legs 84 may be deployed.

Portable elevator 10 may include a motor 92 that supplies power to various components of portable elevator 10, for example, drive mechanism 20, drive units 62, actuators 80 of steering mechanism 64, and outriggers 66. In the illustrated embodiment, motor 92 is hydraulic motor that distributes power to drive units 62 and actuators 80 through a network of pipes and hoses. A hydraulic motor can be beneficial because such motors generally provide high torque, which may be required to move portable elevator 10.

In some embodiments, hydraulic motor 92 may receive power from an electrical transmission line, such as a 220V power receptacle located on a dock of a harbor. In some embodiments, an onboard battery (not shown) may power hydraulic motor 92, thereby allowing self-propulsion of mobile base 12. In some embodiments, an electrical power source may power both hydraulic motor 92 and elevator motor 47.

In order for motor 92 to control each component of portable elevator 10, a control station (not shown) may be provided within elevator car 18, or beside stairway 52. Portable elevator 10 may also be controlled by a radio transceiver (not shown) that is in communication with motor 92, and other components connected to motor 92.

Portable elevator 10 may be operated in a variety of situations, such as transporting goods between levels of a building, or as in some particular embodiments, servicing ships within a harbor. When using portable elevator 10 in a harbor, especially a salt-water harbor, components of portable elevator 10 may include corrosion resistant materials. For example, dynamic components such as steering mechanism 64, rails 36, and motor 92, may be manufactured from stainless steel to reduce the possibility of corrosion as well as other weather related effects. Structural components, for example, those of tower frame 14 and track 16, which may require less corrosion resistance and may be manufactured from aluminum or steel. When using steel, it may be beneficial to treat the steel with corrosion resistant coatings, such as paints, zinc coatings, or the like. Some components of portable elevator 10 may also be manufactured from plastics or composites, which may have greater corrosion resistance in comparison to materials such as stainless steel and coated steel. Materials may also be selected for other properties, such as wear resistance and strength.

In operation, portable elevator 10 may be moved to a location corresponding with lower landing 50a and upper landing 50b, which may be a dock and a ship deck respectively. An operator can drive and steer portable elevator 10 using a wired control pendant in communication with drive units 62 and actuators 80 of steering mechanism 64. While moving, stairway 52 and outriggers 66 are generally in their respective stowed positions. Once at a desired location, outriggers 66 may be folded out and deployed to at least partially support portable elevator 10. In some embodiments, outriggers 66 may wholly support portable elevator 10 such that wheels 60a, 60b are lifted off the ground. In other embodiments, outriggers 66 may support a portion of portable elevator 10 such that wheels 60a, 60b are still in contact with the ground.

Once in the desired location, stairway 52 may be lowered, thereby providing access from lower landing 50a to elevator car 18. If elevator car 18 is not at lower landing 50a, the operator may use the radio transceiver to call elevator car 18 to the lower landing 50a by issuing a command to motor to unravel cable 88. At the lower landing 50a, the operator may open entry door 53 and elevator door 43 to load/unload cargo or other objects between elevator car 18 and lower landing 50a. The operator may then enter elevator car 18, close elevator door 43, and issue a command to elevator motor 47 to raise elevator car 18 to upper landing 50b. At upper landing 50b, the operator may open the elevator door 43 and landing door 54 to load/unload cargo or objects between elevator car 18 and upper landing 50b. In some cases, the operator may need to attach a gangway 59 to landing door 54 in order to provide access between elevator car 18 and upper landing 50b. After loading or unloading elevator car 18, the operator may close elevator door 43 and issue a command to elevator motor 47 to lower elevator car 18 to lower landing 50a. The process of loading/unloading and raising/lowering elevator car 18 may be repeated multiple times. In some embodiments, elevator motor 47 may be configured to include a timer that auto-triggers elevator car 18 to return to the lowered position 18a after a set period of time.

When unloading/loading is complete, portable elevator 10 may be driven to another location. Prior to driving portable elevator, some components may be removed or stowed. In particular, outriggers 66 can be retracted and stowed so that wheels 60a, 60b may fully support the weight of portable elevator. Furthermore, if gangway 59 was attached to landing door 54, it may be detached prior to relocating apparatus 10. Stairway 52 can be folded up and stowed. The operator can use the pendant to drive portable elevator 10 by issuing commands to drive units 62 and actuators 80 of steering mechanism 64.

In the example illustrated, portable elevator moves at a speed of about 5 m/min or less. This can improve safety of the portable elevator 10. One particular safety concern is high winds that may be experienced near harbors and the like.

Portable elevator 10 may be designed to have a mass distribution that can enhance stability of the elevator 10. For example, mobile base 12 may be configured to have a mass corresponding to at least 50% of the total mass of portable elevator. The portable elevator 10 may be designed to have a centre of gravity that is at a vertical height not exceeding 25% of the overall height of the portable elevator 10. The mobile base 12 may include a counter-weight or ballast to achieve such a mass distribution. In general, mobile base 12 has a heavy construction while tower frame 14 and other vertically extending structures have a strong, but lightweight construction.

In the example illustrated, the total mass of the portable elevator 10 is about 27,000 kg. The mobile base 12 has a total mass of about 20,000 kg. The tower frame 14 has a mass of about 5000 kg (about 1000 kg per truss section 27), and the elevator car 18 has a mass of about 2000 kg. This weight distribution has been found to provide satisfactory operation of the portable elevator 10 in windy environments, with wind speeds at least as high as about 80 km/hr.

It is anticipated that portable elevator 10 could operate in winds up to 80 km/hr even if extended to heights of approximately 30 m. For some heights and applications, it may be necessary to increase the wall thickness of tubular structural members 28a, 28b, 28c in tower frame 14 as well as corresponding members in the second latticework 7.

To improve safety, portable elevator may include a wind-monitoring unit (not shown) in communication with motor 92 and elevator motor 47. The wind-monitoring unit may be configured to allow operation of portable elevator 10 only when the wind speed is below a pre-set upper limit (for example, 80 km/hr).

While the above description provides examples of one or more processes or apparatuses, it will be appreciated that other processes or apparatuses may be within the scope of the accompanying claims.

1. A mobile elevator apparatus for transporting people between a ground surface and a raised landing of an adjacent structure, comprising:
a) a base including wheels for rollably supporting the base on a ground surface;
b) a tower frame having a lower end mounted to the base and an upper end above the lower end, the vertical distance between the upper and lower ends defining a frame height;
c) a track secured to the tower frame and extending generally between the lower and upper ends thereof; and
d) an elevator car coupled to the track and movable therealong between raised and lowered positions.

2. The apparatus of claim 1, wherein the base comprises a propulsion device coupled to at least one of the wheels for moving the base over the ground surface.

3. The apparatus of claim 2, wherein the base comprises a steering mechanism coupled to at least one of the wheels for steering the base when moving over the ground surface.

4. The apparatus of claim 1, wherein the tower frame is self-supporting when the elevator car is raised and lowered.

5. The apparatus of claim 4, wherein the tower frame comprises a first latticework around an open shaft extending vertically through the tower frame.

6. The apparatus of claim 5, wherein the elevator car is vertically movable within the shaft.

7. The apparatus of claim 6, wherein the track comprises a second latticework secured to the tower frame at a plurality of connection points along the height of the track.

8. The apparatus of claim 7, wherein the upper end of the tower frame is at greater elevation than the raised landing of the adjacent structure.

9. The apparatus of claim 7, wherein the first latticework and second latticework have heights about equal to the frame height.

10. The apparatus of claim 8, wherein the frame height is at least about 15 m.

11. The apparatus of claim 10, wherein the tower frame has a frame weight of about 5000 kg.

12. The apparatus of claim 11, wherein the base comprises a ballast weight of about 20,000 kg.

13. The apparatus of claim 12 wherein the ballast weight comprises base frame members joined together and having the wheels joined thereto.

14. The apparatus of claim 12 wherein each of the wheels rotates about a wheel axis, the wheel axes aligned in a generally horizontal axle plane, and the base having a center of gravity generally equal to or less than the elevation of the axle plane.

15. A mobile elevator apparatus for transporting people between a ground surface and a raised landing of an adjacent structure, comprising:
a) a base including wheels for rollably supporting the base on a ground surface, a propulsion device coupled to at least one of the wheels for moving the base over the ground surface, and a steering mechanism coupled to at least one of the wheels for steering the base when moving over the ground surface;
b) a tower frame having a lower end mounted to the base and an upper end above the lower end, the vertical distance between the upper and lower ends defining a frame height; the tower frame including a first latticework around an open shaft extending vertically of the tower frame;
c) a track extending generally between the lower and upper ends of the tower frame, the track comprising a second latticework secured to the tower frame between the lower and upper ends thereof; and
d) an elevator car disposed within the shaft and coupled to the track, the elevator car movable along the track between raised and lowered positions.

16. The apparatus of claim 15 wherein the elevator car comprises a base, sidewalls extending upright from the base, and a roof panel secured to the sidewalls opposite the base, the base and roof panel spaced apart a sufficient vertical distance to accommodate a standing adult passenger.

17. A method of providing vertical transport from a ground surface to a gangway of a ship, comprising:
a) providing a mobile elevator apparatus as defined in claim 1; and
b) driving the apparatus to a position adjacent said ship with the tower in alignment with said gangway.

18. The method of claim 17, wherein the method is free of anchoring the apparatus to the ship.

19. The method of claim 17, further comprising providing the apparatus with a controller including at least one sensor for stopping upward motion of the elevator car when in the raised position, and further comprising the step of positioning a triggering element along the tower frame to trigger the sensor when the elevator car is in the raised position.

20. The method of claim 17 wherein the controller comprises a menu of ship names to be serviced, the at least one sensor having a corresponding position for each ship name, and wherein the method includes selecting the ship name of said ship being serviced to set the elevation of the elevator car when in the raised position.
